(19) United States
(12) Patent Application Publication
(10) Pub. No.: US 2017/0185328 A1
(43) Pub. Date: Jun. 29, 2017

(54) NAND FLASH STORAGE ERROR MITIGATION SYSTEMS AND METHODS

(71) Applicant: Alibaba Group Holding Limited, George Town (KY)

(72) Inventor: Shu LI, Santa Clara, CA (US)

(21) Appl. No.: 14/983,361

(22) Filed: Dec. 29, 2015

(51) Int. Cl. G06F 3/06

(52) U.S. Cl. CPC G06F 3/0619; G06F 3/064; G06F 3/0679

(57) ABSTRACT

The present invention facilitates efficient and effective information storage device operations. In one embodiment, a storage device comprises: a plurality of storage cells configured to store information; a plurality of word lines coupled to the plurality of storage cells; and a plurality of bit lines coupled to the plurality of storage cells, wherein the plurality of bit lines are configured to enable writing of the plurality of storage cells and the plurality of word lines are configured to enable reading of the storage cells. The information is configured in a plurality of information first type portions (e.g., codewords) which respectively include a plurality of second type portions (e.g., data chunks), and the information is stored by the plurality of storage cells in a distribution that ensures two second type portions from a respective first type portion are not stored in storage cells adjacent to one another.

### FIELD OF THE INVENTION

The present invention relates to the field of solid state storage devices.

### BACKGROUND OF THE INVENTION

Numerous electronic technologies such as digital computers, calculators, audio devices, video equipment, and telephone systems facilitate increased productivity and cost reduction in analyzing and communicating data, ideas, and trends in most areas of business, science, education, and entertainment. Frequently, these activities involve storage of information in NAND flash drives. However, there are a number of factors that can impact information storage, including life expectancy of storage components, storage density, information access speed, manufacturing costs, maintenance, and so on.

NAND flash products like solid state drives (SSDs) typically facilitate relatively rapid access to stored information but tend to have degradation effects which detrimentally impact performance and reduce the device's effective lifespan. Traditionally, solid state storage cells can only be reliably programmed or erased a limited number of cycles, after which they begin to become unreliable and fail. Conventional SSD attempts at overcoming the problems are typically implemented in firmware and are usually limited to wear leveling implemented at a storage block level (e.g., to track and balance erasing operations performed on a block basis). In addition, conventional wear leveling is typically based on the assumptions that storage blocks have the same initial health condition, and also that their wear-out speed/rate is the same across multiple drives. These assumptions are not typically true in the practical or real world since the quality of storage blocks can vary in reality.

A storage operation (e.g., read, write, program, etc.) is typically directed at a particular amount of storage capacity. The size or granularity of storage capacity that storage operations are directed at can be based upon an analysis of a variety of things. Performing storage operations directed at smaller or finer granularity size storage capacities usually involves increased control complexity and greater consumption of resources for control operations. Thus, conventional systems typically try to perform the operations based upon larger size portions.

However, directing storage operations at a larger size or larger granularity storage capacity (such as block size and so on) may result in the premature loss or deactivation of otherwise reliable finer granularity storage resources (such as pages, words, and so on). When storage pages in a storage block have different bit error rates, the distribution of the page bit error rates become wider and the conventional lifespan of the storage block is shorter. This impact is a relatively straightforward result of constraints associated with the conventional approaches. The constraints often include a rule that as long as one page's bit error rate in a block exceeds the correction capability of the ECC codec, then the whole block is treated as a bad block. Traditionally, bad blocks are handled by bad block management firmware and no matter how reliable or “healthy” the other pages in the block are, the block is not used any more. Thus, a number of reliable and healthy pages are essentially retired prematurely.

### SUMMARY

The present invention facilitates efficient and effective information storage device operations. In one embodiment, a storage device comprises: a plurality of storage cells configured to store information; a plurality of word lines coupled to the plurality of storage cells; and a plurality of bit lines coupled to the plurality of storage cells, wherein the plurality of bit lines are configured to enable writing of information to the plurality of storage cells and the plurality of word lines are configured to enable reading of the information from the storage cells. The information is configured in a plurality of information first type portions (e.g., a block, a page, etc.) which respectively include a plurality of second type portions (e.g., a codeword, a data chunk, etc.), and the information is stored by the plurality of storage cells in a distribution that ensures two second type portions from a respective first type portion are not stored in storage cells adjacent to one another.

In one exemplary implementation, the first type portion is a codeword and the second type portion is a chunk of data or data chunk. The information is distributed so that codewords are divided into the data chunks and the data chunks are interleaved in the plurality of storage cells included in a storage block. The distribution can evenly spread the second type portions across the plurality of storage cells included in a storage block. The second type portions are evenly spread over the storage block even if noise is not averaged or evenly distributed. Page-to-page variation is mitigated by the distribution of information from a single logical page to a plurality of physical pages within a block. A bit level in one of the plurality of transistors associated with the storage cells can be programmed in one step without an intermediate transition.

A mitigation arrangement method includes: receiving information for storage; encoding the information in codewords; dividing the codewords into portions of codewords; and distributing the portions so that two portions from a single codeword are not stored in adjacent physical storage cells. The codewords can be associated with a logical storage page based upon a logical relationship of the codewords. Two portions from a single codeword associated with the logical storage page are stored in two different physical storage pages. A resulting storage arrangement facilitates error correction and fault tolerance and increases device longevity. In one exemplary implementation, a logical page is divided into data chunks of encoded data and the data chunks of encoded data are arranged to ensure logically related data chunks from logical pages are distributed over the block of physical storage pages. A storage cell can include a transistor and be either a single bit or multiple bit storage cell.

### DESCRIPTION OF THE DRAWINGS

The accompanying drawings, which are incorporated in and form a part of this specification, are included for exemplary illustration of the principles of the present invention and are not intended to limit the present invention to the particular implementations illustrated therein. The drawings are not to scale unless otherwise specifically indicated.

FIG. 1 is a block diagram of an exemplary NAND flash memory block in accordance with one embodiment of the present invention.

FIG. 2 is an illustration of information organized in a logically based hierarchy of information subsets or subgroupings in accordance with one embodiment.

FIG. 3 is an illustration of an example configuration or organization of information in physical storage locations after mitigation arrangement of information from the logically configured subgroups in accordance with one embodiment.

FIG. 4 is an exemplary graph illustrating a hardware failure rate curve in accordance with one example.

FIG. 5 is a histogram of the number of errors in pages (or page error rate distribution) of NAND flash products that were observed and collected in an exemplary data center production environment in accordance with one exemplary implementation.

FIG. 6 is a block diagram illustrating the results of distributing the noise condition of high error rate pages in accordance with one embodiment.

FIG. 7 is a flow chart of an example mitigation arrangement method in accordance with one embodiment.

FIG. 8 shows the architecture and work flow of an example information mitigation arrangement system in accordance with one embodiment.

FIG. 9 is a block diagram of an example NAND flash structure in accordance with one embodiment.

FIG. 10 is a block diagram illustrating exemplary multi level cell (MLC) programming sequences in accordance with one embodiment.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one ordinarily skilled in the art that the present invention may be practiced without these specific details. In other instances, well known methods, procedures, components, and circuits have not been described in detail so as not to unnecessarily obscure aspects of the current invention.

In one embodiment, storage of logically related information in various physical storage locations is arranged in a manner that facilitates a number of objectives (e.g., leveling of page error rate distributions, increased longevity, decreased interference, reduced hotspot failures, improved fault tolerance, facilitate error correction, etc.). The mitigation arrangement includes changing the arrangement or configuration of adjacently related logical information to nonadjacent physical storage locations. Portions of information from a logically related codeword is stored in a plurality of physical storage pages, which increases the probability that more portions of a codeword are in low error rate pages and are readable. This in turn increases the probability that error correcting logic can recover a non-readable portion. The ability to recover more codewords of information facilitates improved device performance and longevity.

It is appreciated that information can be organized in a variety of configurations. Information can be organized or configured in subsets or subgroupings of information portions or pieces and there can be a hierarchy of subsets or subgroupings. For example, a relatively large portion of information is divided into subsets or subgroupings of information portions or pieces which are further divided into more subsets or subgroupings. For ease of convention, different sizes of subsets or subgroupings of information are given different size indicators or names. In one embodiment, a relatively large subset or subgrouping of information is referred to as a block which is further divided into subsets or subgroupings referred to as pages. The pages are divided into subsets or subgroupings of information referred to as words and the words are further divided into subsets or subgroupings referred to chunks or data chunks. Thus, a block includes a plurality of pages, a page includes a plurality of words and a word includes a plurality of data chunks. The data chunks can be the same or different sizes or amounts of information.

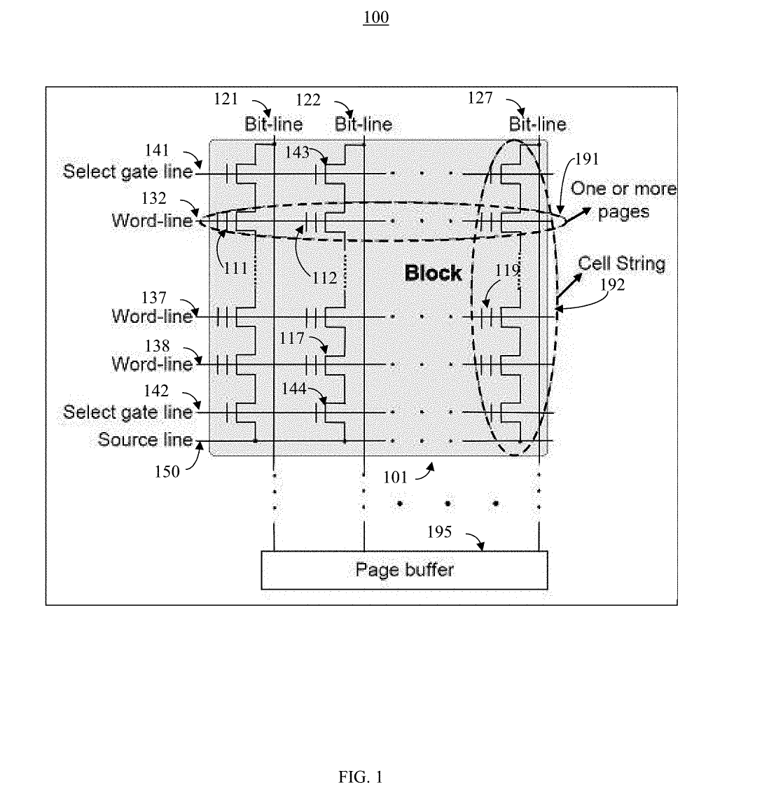

FIG. 1 is a block diagram of an exemplary solid state storage device 100 in accordance with one embodiment of the present invention. Solid state storage device 100 includes a plurality of storage cells (e.g., 111, 112, 117, and 119), bit lines (e.g., 121, 122, and 127), word lines (e.g., 132, 137, and 138), select gate lines (e.g., 141 and 142), and source line 150. The word lines are coupled to the plurality of the storage cell. The bit lines can also be selectively coupled to the plurality of storage cell. The select gate lines are coupled to select gate transistors (e.g., 143, 144, etc.) while the source line is coupled to the bit lines. The source line conveys a source voltage and the select gate lines selectively activate select gate transistors coupling the source voltage to storage cell transistors. The solid state storage device can also include a page buffer 195 coupled to the bit lines.

In one embodiment, the plurality of storage cells includes transistors organized in rows and columns. A row of transistors is associated with or coupled to a word line and a column of transistors is associated with or coupled to a bit line. A word line is also associated with a physical page and a bit line can be associated with a cell string. For example, word line 132 is associated with physical page 191 and bit line 127 is associated with cell string 192. A plurality of physical storage pages are associated or organized in a group referred to as a block (e.g., block 101). Multiple pages can share the same wordline and the source gate controls which page is accessed. In other words, the bitlines in the same page share the same wordline, but the bitlines sharing the same wordline may belong to different pages. Since a data chunk is a subset of a page, the data chunk can be considered information corresponding to a group of bitlines. It is appreciated that various operational activities can be performed at various levels of granularity or organization of subsets or subgroupings of information. For example, programming, reading, and writing operations can be performed on a block size subset basis, a page size subset basis, or storage cell basis.

There is a relationship between logical organization or configuration of the information and physical storage organization or configuration of the information. In conventional approaches, there is typically an identical or very strong correlation between inclusion of information in both a logical subset or subgrouping unit and a corresponding physical storage subset or subgrouping unit. For example, traditionally the information included in a single logical storage subset or unit (e.g., page, word, etc.) is also typically included in a single corresponding physical storage subset or unit (e.g., page, word, etc.). However, in mitigation arrangement or distribution systems and methods, there is less correlation between inclusion of information portions in a single logical subset or subgrouping unit and a corresponding single physical storage subset or subgrouping unit. In one embodiment, information included in a single logical subset (e.g., page, word, etc.) is distributed or spread out to multiple corresponding physical storage subsets (e.g., page, word, etc.). The mitigation arrangement or distribution approach spreads data chunks from a single logical page within a block over multiple nonadjacent physical storage page locations within the block.

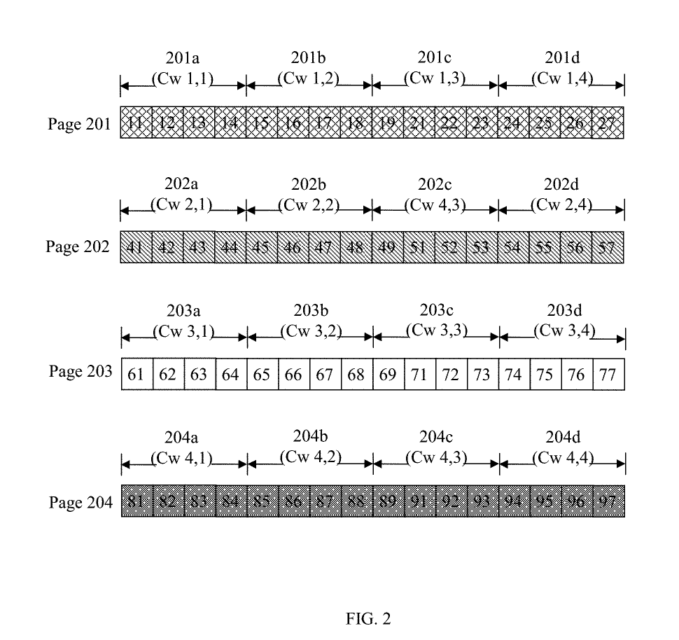

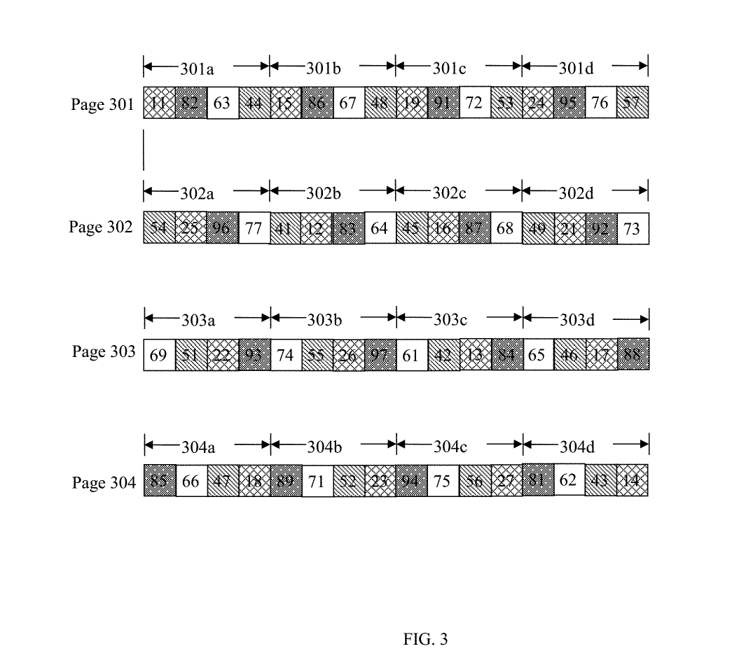

Together, FIG. 2 and FIG. 3 are illustrations of example information distributions or configurations before and after the mitigation arrangement respectively in accordance with one embodiment. FIG. 2 is an illustration of information organized in a logically based hierarchy of information subsets or subgroupings before mitigation arrangement in accordance with one embodiment. The hierarchy includes information portions arranged in logical pages which include logical words. The logical words include subsets or subgrouping of information portions referred to as data chunks. The logical words can be codewords that include encoded information stored in an error correcting codec (ECC) memory or storage device.

FIG. 2 is an illustration of an example configuration or organization of information in logically related locations before mitigation arrangement or distribution of the information in accordance with one embodiment. For example, FIG. 2 includes pages 201, 202, 203, and 204. Logical page 201 includes logical codewords 201a (Cw 1,1), 201b (Cw 1,2), 201c (Cw 1,3), and 201d (Cw 1,4) divided into data chunks 11 through 27. Logical page 202 includes codewords 202a (Cw 2,1), 202b (Cw 2,2), 203c (Cw 2,3), and 204d (Cw 2,4) divided into data chunks 41 through 57. Logical page 203 includes logical codewords 203a (Cw 3,1), 203b (Cw 3,2), 203c (Cw 3,3), and 203d (Cw 3,4) divided into data chunks 61 through 77. Logical page 204 includes logical codewords 204a (Cw 4,1), 204b (Cw 4,2), 204c (Cw 4,3), and 204d (Cw 4,4) divided into data chunks 81 through 97. In FIG. 2, data chunks with the same shading are organized or configured to be in the same logical page.

FIG. 3 is an illustration of an example configuration or organization of information in physical storage locations after mitigation arrangement or distribution of the information in accordance with one embodiment. The mitigation arrangement or distribution includes arranging the proximity or organization of the divided logically related subgrouping of encoded information portions (or data chunks) when they are stored in a physical storage location based hierarchy. The mitigation arrangement results in the logically related subgroupings of information portions (or data chunks) being more widely distributed or spread throughout nonadjacent physical storage block locations. FIG. 3 illustrates the physical storage location relationship after the mitigation arrangement (e.g., arrangement of logical storage block organization or configuration in FIG. 2). For example, comparing some of the information organization of FIG. 2 and FIG. 3, in physical storage page 302, the first data chunk is 54, which was previously the first data chunk 54 of the logical page 204′s last logical codeword 202d (Cw 4,4), and the second data chunk 25 is the second data chunk of the original page 201's last logical codeword 201d (Cw 1,4). Again in FIG. 3, data chunks with a similar shading pattern are from the same original logical pages illustrated in FIG. 2. FIGS. 2 and 3 together graphically illustrate the mitigation arrangement or distribution of the data chunks between the FIG. 2 logical configuration and the FIG. 3 physical storage configuration.

It is appreciated that the mitigation arrangement is applicable to a variety of different implementations and embodiments. The amount of information and configuration or division of the information in subsets or subgroupings can vary. The division of information within a page is not limited to particular number of pieces or chunks of information. The size or amount of information included in a chunk or subset can also vary. In one embodiment, a page includes 8 Kbytes and 512 pages per block (aproximately 4 Mbytes per block). It is also appreciated that FIGS. 2 and 3 are one exemplary implementation of the rearragment of data chunks and there can be different formats or rearrangements of the data chunks that facilitate mitigation of error rate variations or noise.

In one embodiment, storage devices perform various operations (e.g., read, write, program, erase, track device perfomance statistics, etc.) based on the sets or subgroups of information (e.g., a page, a block, etc.). Some types of storage devices perform read and write storage operations on a page basis, but perform erase operations on a block basis. In one exemplary implementation, a storage system receives a request to return information from data chunks 11, 12, 13, and 14. In a conventional approach, data chunks 11, 12, 13, and 14 from the logical word 201a in FIG. 2 would be stored in a physical storage page similar to physical storage page 301 at codeword 301a, and if the physical storage page was bad then there would not be enough information from data chunks 11, 12, 13, and 14 for an ECC storage device to successfully recover the information. In the mitigation arrangement approach, data chunks 11, 12, 13, and 14 are distributed. As illustrated in FIG. 3, data chunk 11 is stored in the first position of physical page 301, data chunk 12 is stored in the sixth storage position of physical page 302, data chunk 13 is stored in the eleventh storage position of physical page 303, and data chunk 14 is stored in the last storage position of physical page 304. Thus, if storage page 301 is bad and data chunk 11 is not accessible, data chunks 12, 13, and 14 in physical storage pages 302, 303, and 304 are accessible and the ECC codewords can be used to recover data chunk 11, unlike the conventional approach example in which the data chunks 11, 12, 13 and 14 were neither accessible nor recoverable.

In the conventional approach, if the codeword 201a and data chunks 11, 12, 13, and 14 are neither accessible nor recoverable, then the corresponding physical storage page in the conventional system is considered bad and when the limit of bad pages per block is hit the whole block is marked as bad even though there may be many other pages in the block that are considered good. In the mitigation arrangement approach, the codeword 201a and data chunks 12, 13 and 14 are accessible and are used by ECC logic to recover data chunk 11. Thus, neither physical storage page 301 nor the corresponding physical storage block are marked as bad as a result of receiving a request for information included in data chunks 11, 12, 13, and 14.

Storage operations directed at smaller or finer granularity portions of information usually involve greater device complexity and consumption of resources (e.g., resources used for information evaluation, tracking, handling, etc. associated with the operations). For example, if the control logic (e.g., flash translation layer (FTL), etc.) attempts to work on units of smaller size or finer granularity subsets or subgroups of information, the amount of work and resource consumption while the storage device is operating is considerable. However, larger size or granularity portions of information can give rise to a number of inefficiencies and waste resources. Some systems operate on the basis that if a portion of a larger size operation unit or information has an error or is bad, then the whole unit is considered bad or disabled, even though there may be other portions in the unit of information that are good. In one traditional approach, if some pages in a block have an error or are bad the whole block is considered bad or disabled, even though there are other pages in the block that are still good. Thus, performing operations based on larger size or granularity portions of storage resources (such as a block size and so on) may result in the premature loss or deactivation of otherwise reliable finer granularity storage resources (such as pages, words, and so on).

The different impacts associated with the different sizes of information subsets or units have a significant role in analysis and decisions regarding which sizes to implement or utilize for storage operations. In a number of storage devices, there can be two competing design criteria or objectives, such as low cost and resource consumption versus premature loss or deactivation of otherwise reliable storage resources. This forms the basis of the problematic traditional approach trade-off dilemma or question of what to pay (e.g., in terms of resource consumption, complexity, etc.) versus what to gain (e.g., ease of implementation, device longevity, etc.). Traditional attempts at resolving error distribution problems and increasing device longevity are typically directed at changing the FTL resulting in the whole control scheme becoming much more complicated.

The mitigation arrangement approach does not necessarily involve extensive changes in the storage control scheme. In one exemplary flash storage system, the mitigation arrangement approach does not change the FTL itself and, thus, does not incur the additional costs associated with traditional attempts at preemptive handling of the errors. Unlike traditional approaches to handling error rates distribution which are directed at changing the FTL for use with smaller units or subsets of information (resulting in the whole control scheme becoming much more complicated), the mitigation arrangement of data chunks is a self-adaptive method that permits FTL management operations to proceed at a block level. The mitigation arrangement self-adaptive method helps achieve the goal of mitigating the page-to-page variation without complicating the FTL.

Unlike traditional attempts, the arrangement mitigation is not dependant or adversely impacted by many real world implementation aspects. Many conventional wear leveling approaches are based on the assumptions that storage blocks have the same initial health condition and also that their wear-out speed/rate is the same across multiple devices. These assumptions are not typically accurate in the practical world since the quality of storage blocks varies.

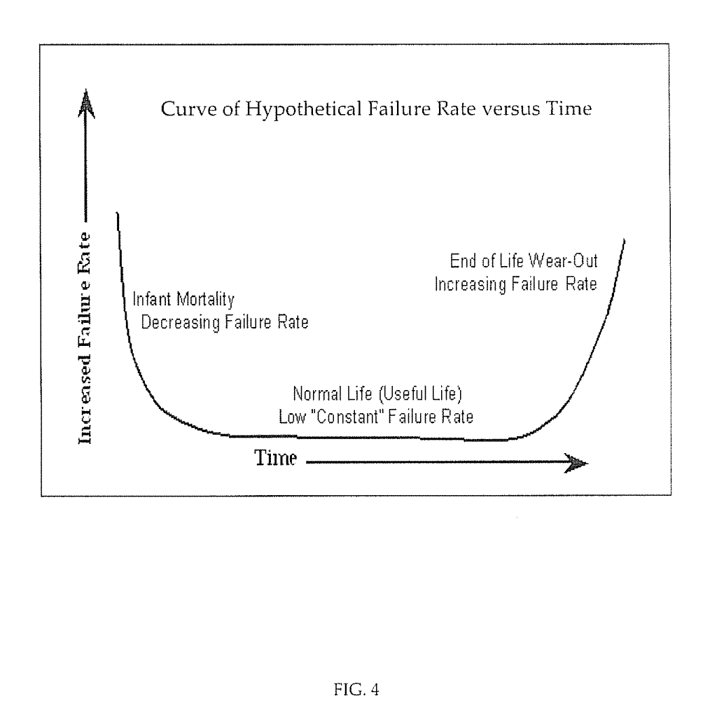

FIG. 4 is an exemplary graph illustrating a hardware failure rate curve in accordance with one example. The curve can be considered to have a shape similar to the outline of a bathtub with two sides rounding into a relatively flat bottom. At the initial stage of usage, the fault rate is high and with further use, the failure rate decreases to a flat or platform stage and the system proceeds to work relatively stable for a period of time. Then, when approaching the end of the life, the system's failure rate increases due to the device wear-out, conductivity deterioration, and so on. It is appreciated that a variety of things can impact the varied quality of storage blocks.

The quality of storage blocks can be impacted by the error rate and endurance of the device at the burn-in stage. Burn-in usually involves the first few dozen programming and erasing operations after the storage device die is packaged and assembled on a printed circuit board (PCB), and errors or failures encountered during the burn-in stage can be resolved before shipment to end users. Given the relatively steep burn-in example hardware failure rate curve, before the system is sent out from the manufacturer, it is deliberately used or worn for a certain period of time (e.g., during burn in) so that device characteristics enter the relatively flat bottom region of curve. Thus, end users do not typically suffer or experience the high failure rate at the left side of curve. In one exemplary implementation, during the burn-in stage some weak blocks can be filtered out.

Wear-out is not necessarily limited to the burn in stage. The speed at which a device wears out during the whole usage process can also impact the quality of the storage blocks. Even blocks that are at the same level at the beginning of the normal usage or platform stage (e.g., beginning of the flat part of the curve) can deteriorate at different rates resulting in some blocks deteriorating faster than others. The blocks that wear out faster can be identified and tracked during the normal or online usage. The corresponding block management strategy, including wear leveling and bad block management, can be adjusted accordingly (e.g., to level failure rates, increase over block life time usage, etc.).

The quality of storage blocks can also be impacted by conventional bad block management approaches. For some conventional information storage products, when the number of bad blocks reaches certain threshold, the whole device is locked as read-only even though there may be many pages that are still in good condition and otherwise capable of further reliable usage. Thus, a variety of conditions and activities over the life of devices can impact error rate distributions.

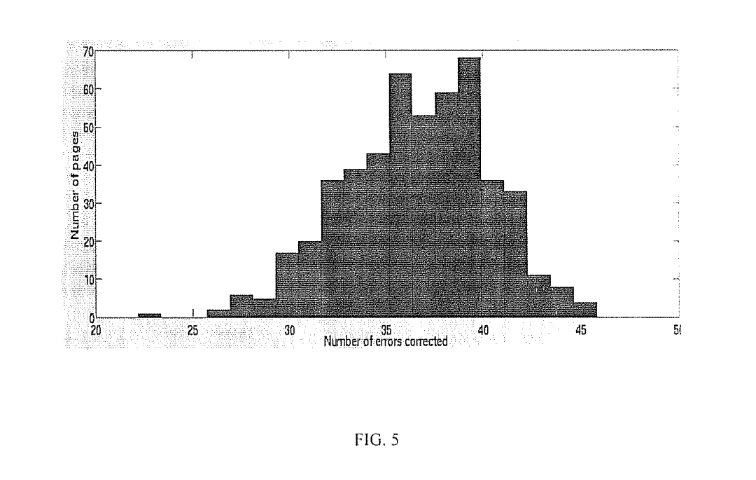

In traditional storage systems, the bit error rates typically vary from page to page and variations in bit error rates between pages usually have certain deviations. FIG. 5 is an exemplary histogram of the number of errors in pages or page error rate distribution of NAND flash products in one exemplary data center production environment. The pages associated with the right side tail of the error rate distribution histogram have a relatively high error rate per page and are generally referred to as the worst case. The higher error rate pages can traditionally cause significant issues because the system design often has to guarantee that the worst case gets covered or handled. In other words, even though the over all averaged error rate may be 0.001, in order to ensure acceptable reliability, the system has to be able to handle the relatively few pages with a higher error rate, for example a 0.01 error rate. Conventional attempts at handling this one magnitude difference typically lead to extensive and expensive resource consumption in efforts directed at completely different SSD designs.

In the mitigation arrangement or distribution approach, the correlation or association of data chunks in a logical configuration to data chunks in a physical storage configuration is changed. Storing the information in a mitigation arranged or distributed configuration helps moderate error rate distribution deviations and ease extremes, thereby improving worst case scenarios. The relatively few occurrences of the extreme worst case page error rates (those on the far right of the distribution graph in FIG. 5) can be considered “noise” (due to the rare occurrence) with respect to the bulk or majority of page error rates. By changing or manipulating association or arrangement of data chunks between logical configuration positions and physical storage positions, the noise interference of pages with bad error rates is mitigated or averaged down. For example, since the information originally configured in a logical based page is spread to different nonadjacent physical storage locations, the original page-to-page error rate variation is averaged down.

The error rates of pages change, and some pages may have high error rates. In traditional storage approaches information in these high error rate pages cannot typically be recovered. In a mitigation arrangement approach, the high error rate pages are used to store data chunks from lots of different ECC (error correction code) codewords. This results in the high noise energy or impact associated with the high error rate pages being distributed across more ECC codewords. The error rates for the ECC codewords get balanced and compensated for due to over all effects resulting from the mitigation arrangement of data chunks from lots of different codewords.

In one embodiment, erasure decoding is used. The boundaries of chunks are clear from the chunk mitigation arrangment. The suspicious chunks going through the more noisy pages can be located by trial. According to the information theory basics, the linear block code's erasure decoding can correct more errors and the error correction capability is improved.

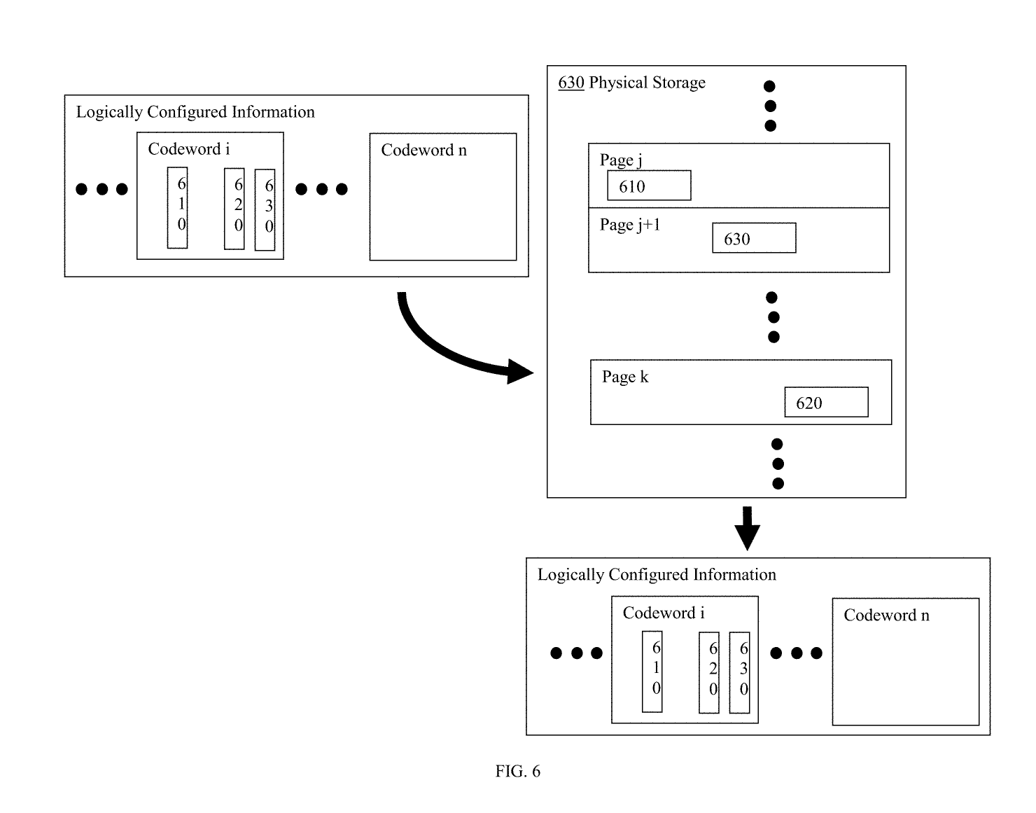

FIG. 6 is another exemplary block diagram illustrating mitigation distribution in accordance with one embodiment. Codeword i includes data chunk portions 610, 620, and 630. Page j is a relatively high error rate page and pages j+1 and k are relatively low error rate pages. Without the mitigation arrangement, the content of the codeword i would be stored in page j with a high error rate and the information can not be retrieved. Without mitigation arrangement, these pages with high error rates (e.g., in the right hand long-tail side of the histogram in FIG. 5) set the lower bound of an acceptable page fault rate the system is designed to handle. With data chunk mitigation arrangement, as shown in FIG. 6, a small portion of the information 610 from a codeword i is stored in the high error rate physical storage page j and more of the information (e.g., 620, and 630) from the codeword i stored in lower error rate pages j+1 and k.

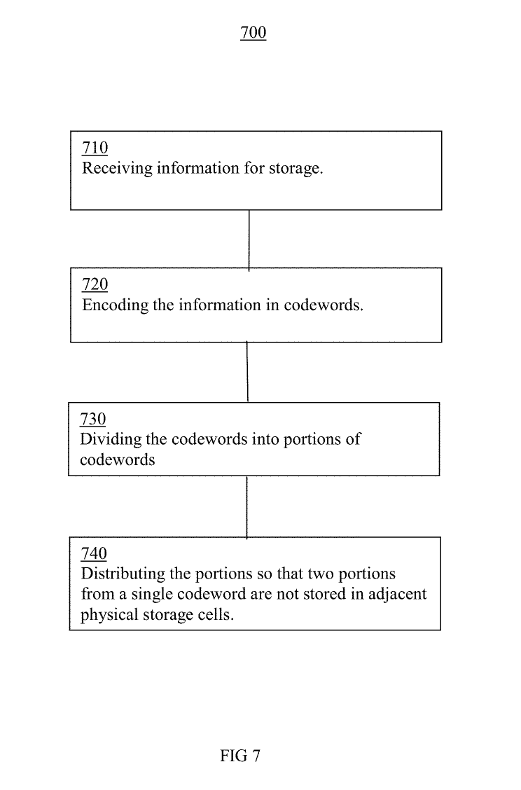

FIG. 7 is a flow chart of an example mitigation arrangement method 700 in accordance with one embodiment. The mitigation arrangement can apply to various different types of data blocks, including normal blocks, over-provisioning blocks, and so on. The mitigation arrangement helps reduce fault rates and improve the probability of sucessful data reads and writes.

In block 710, information for storage is received. The information includes logically related information.

In block 720, the information is encoded into codewords. The encoding can include ECC encoding.

In block 730, the codewords are divided into portions of codewords. The portions are configured in data chunks.

In block 740, the portions are distributed so that two portions from a single codeword are not stored in adjacent physical storage cells. In one embodiment, the portions are interleaved over multiple storage pages.

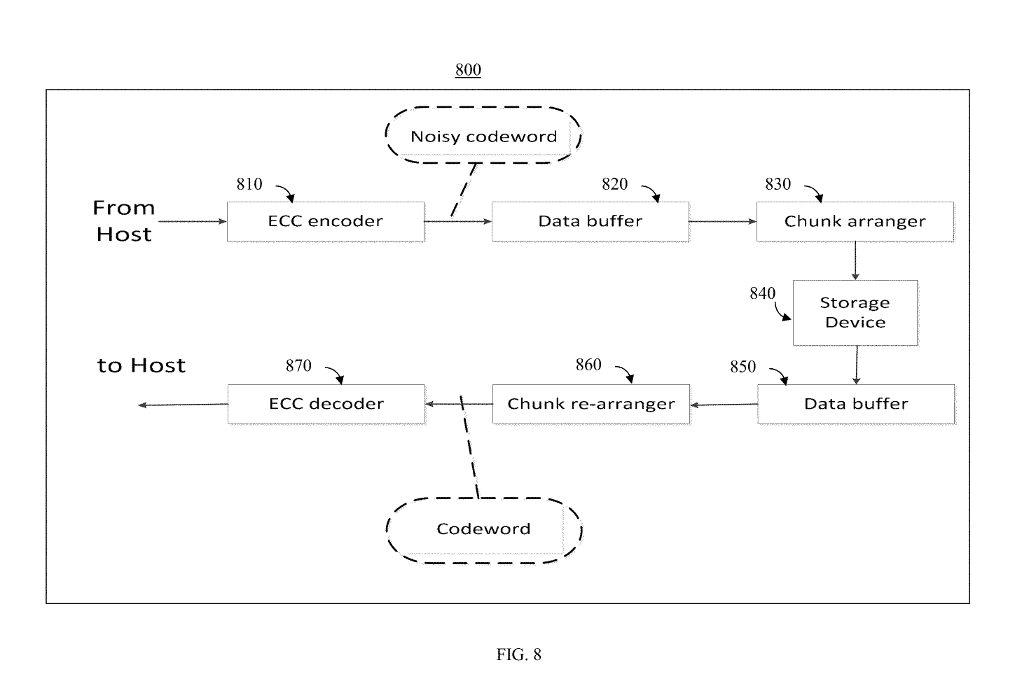

FIG. 8 shows the architecture and work flow of an example information mitigation arrangement system 800 in accordance with one embodiment of the present invention. The information mitigation arrangement system 800 includes: error correction code (ECC) encoder 810, input data buffer 820, data chunk arranger 830, storage device 840, output data buffer 850, data chunk rearranger 860, and ECC decoder 870. An input path includes ECC encoder 810 coupled to input data buffer 820, which is coupled to data chunk arranger 830, which in turn is coupled to storage device 840. An output path includes storage device 840 coupled to output data buffer 850, which is coupled to data chunk rearranger 860, which in turn is coupled to ECC decoder 870.

The components of information mitigation arrangement system 800 cooperatively operate to store information arranged in accordance with one embodiment of the present invention. User data or information is received from a host device (not shown) and forwarded to EEC encoder 810. After the user data is encoded by ECC encoder 810, the information is arranged in a configuration compatible with a physical page and it is buffered in data buffer 820. In one exemplary implementation, the buffer size is large enough to hold the pages in one block (e.g., 256, etc.). The information is divided into multiple data chunks which may not necessarily always have the same length. The information can be organized in a hierarchy of information. At one level, the information within a subgroup can be maintained regardless of whether it is logically organized or physically organized. At another level the information can be spread across logically organized or physically organized subgroups. In one exemplary implementation, information within a block subgroup is maintained within corresponding blocks regardless of whether the block is logically or physically organized, whereas information within page subgroups is arranged or distributed across different pages between logically and physical organized configurations. In data chunk arranger 830 the data chunk mitigation arrangement mapping is chosen and the data chunks are arranged or moved around to form the mitigation sequence to be programmed into storage device 840.

At the output side the data chunks are output from storage device 840 into the data buffer 850. In one embodiment, the data buffer 850 is much larger than the capacity of one flash block. Caching the information can improve read hits to accelerate the read operation. The data chunk mitigation arrangement is reversed in data chunk rearranger 860 back to a sequence similar to which it was received. With the data chunks from different physical locations in the storage block put back in a sequence similar to the logical configuration, the ECC decoder 870 corrects errors and sends the data back to the host (not shown).

It is appreciated that a variety of things can impact storage errors. Cell-to-cell interference (e.g., coupling effect) in solid state products often results from the close proximity of storage cells to one another. The problem is exacerbated in many conventional approaches that attempt to place cells closer to one another in response to demands for high-capacity high-density storage. In these traditional approaches in which solid state storage cells are relatively close to one another (e.g., due to the fabrication technology scale-downs), when one cell is programmed the electromagnetic field applied during programming will often affect the adjacent cells. In one embodiment, a cell is the smallest unit (which stores information bits, logical ones and zeros, etc.) in a solid state device. In one exemplary implementation, a cell is a physical transistor with floating gates. For single level cell (SLC) storage components, one cell includes one bit. For multi level cell (MLC) storage components, one cell includes two bits. For triple layer cell (TLC) storage components, one cell includes three bits. There is also quad level cell (QLC) storage component which includes four bits in one cell. In one embodiment, the mitigation arrangement or distribution facilitates reduction of coupling effect impacts or interference between storage cells.

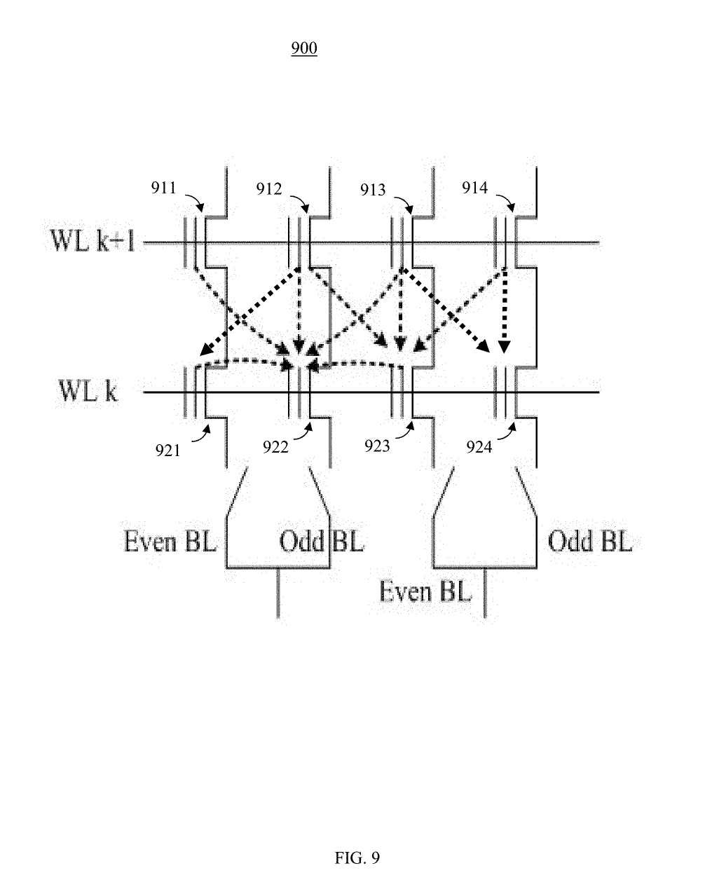

FIG. 9 is a block diagram of an example NAND flash structure 900 in accordance with one embodiment. The structure includes a densely aligned cell array in which storage cells are fabricated on the cross points of bit lines and word lines. The NAND flash structure 900 includes storage cells 911, 912, 913, 914, 921, 922, 923, and 924. Both the reading and programming of a cell or cells generate an electromagnetic field which can affect the threshold voltage of nearby or victim cells. The dashed lines and arrows in FIG. 9 emphasize the read disturbance effect or interference of one cell on another. For example, cell 922 is impacted by interference from accesses directed at cells 911, 912, 913, 921, and 923. A page on word line k+1 and a page on word line k store hot data which is frequently accessed. Interference changes the charge trapped in the cell 922 when the ells 911, 912, 913, 921, and 923 are accessed. When the coupling effect accumulates to a certain level, this cell's threshold voltage will be moved across the sensing boundary of flash, which directly causes an error.

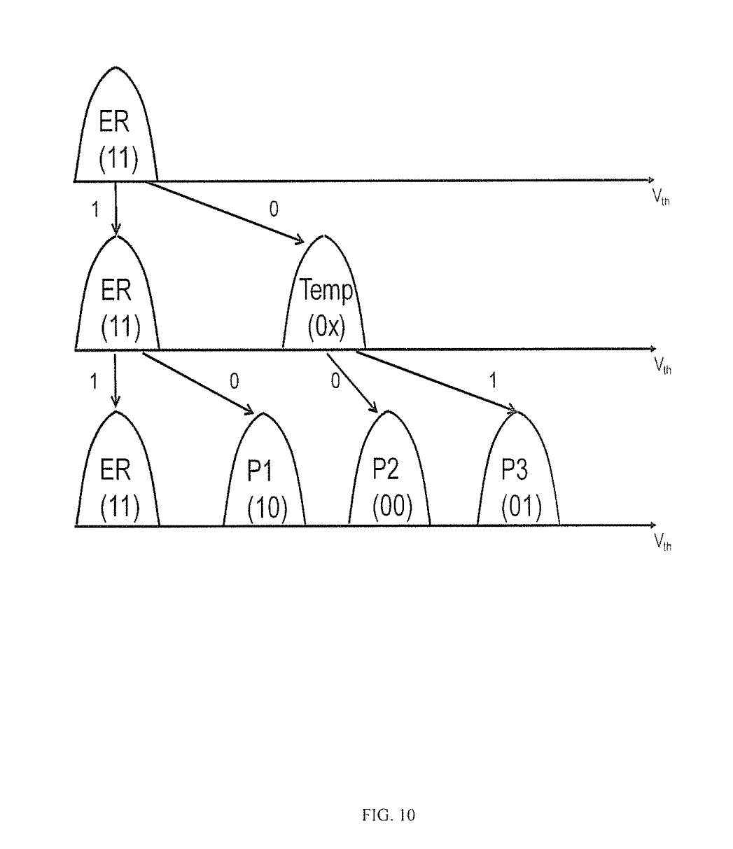

Existing conventional systems often attempt to mitigate cell-to-cell interference by separating the MLC flash programming into two steps as LSB and MSB. FIG. 10 is a block diagram illustrating exemplary MLC programming sequences in accordance with one embodiment. To program the two bits of an MLC cell, the least significant bit (LSB) is programmed at a first step with a temporary level of threshold voltage, Vth. Then, after some (but not necessarily all of its neighboring cells) get programmed, this cell's most significant (MSB) is programmed to form one of four levels corresponding to four logical values (e.g., 11, 10, 00 and 01). However, since it is usually unavoidable that some adjacent cells are programmed later, most cells are impacted by the cell-to-cell interference causing corruption and errors in the stored information. In traditional systems in which information from a single logical codeword without mitigation arrangement is stored in adjacent storage cells, the probability of cell to cell interference increases the chances of errors without the ability to recover. In a mitigation arrangement system in which information from a single logical codeword is arranged and stored in nonadjacent storage cells, the probability or the cell to cell interference decrease and the chances of recovering from if an error does occur increases. The occurence of coupling effects is highly related to the programming sequence of flash pages, and some traditional systems attempt to improve or optimize the programming sequence on a page by page basis. In addition to programming sequence adjustments, the data chunk mitigation arrangments facilitate adjustments to the programming sequence with a much finer granularilty based on data chunks.

It is appreciated that mitigation arrangement deployment can utilize a variety of configuration formats that help promote various objectives (e.g., longer life span, noise mitigation, etc.). The mitigation arrangement can help mitigate page-to-page variation issues by changing the arrangement or configuration of original logical pages divisions when storing in the physical storage pages. In one embodiment, the mitigation arrangement evenly distributes the logically connected data onto discrete physical locations and the cell-to-cell interference is reduced. The mitigation arrangement can facilitate efficient management and use of NAND flash products. In addition, control of hot spots with high likelihood of failure can also be improved. Furthermore, since the same ECC codeword is spread out instead of being within the same physical page with high error rate, the erasure decoding improves the fault tolerance of flash product. Given the example of minimal distance separate code, like RS code, the error correction capability of erasure decoding can be doubled compared with current conventional ECC approaches.

Some portions of the detailed descriptions are presented in terms of procedures, logic blocks, processing, and other symbolic representations of operations on data bits within a computer memory. These descriptions and representations are the means generally used by those skilled in data processing arts to effectively convey the substance of their work to others skilled in the art. A procedure, logic block, process, etc., is here, and generally, conceived to be a self-consistent sequence of steps or instructions leading to a desired result. The steps include physical manipulations of physical quantities. Usually, though not necessarily, these quantities take the form of electrical, magnetic, optical, or quantum signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that of these and similar terms are associated with the appropriate physical quantities and are merely convenient labels applied to these quantities. Unless specifically stated otherwise as apparent from the following discussions, it is appreciated that throughout the present application, discussions utilizing terms such as “processing”, “computing”, “calculating”, “determining”, “displaying” or the like, refer to the action and processes of a computer system, or similar processing device (e.g., an electrical, optical, or quantum, computing device), that manipulates and transforms data represented as physical (e.g., electronic) quantities. The terms refer to actions and processes of the processing devices that manipulate or transform physical quantities within a computer system's component (e.g., registers, memories, other such information storage, transmission or display devices, etc.) into other data similarly represented as physical quantities within other components.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. The listing of steps within method claims do not imply any particular order to performing the steps, unless explicitly stated in the claim.

What is claimed is:

1. A NAND flash storage device comprising:
a plurality of storage cells configured to store information;
a plurality of word lines coupled to the plurality of storage cells; and
a plurality of bit lines coupled to the plurality of storage cells, wherein the plurality of bit lines are configured to enable writing of information in the plurality of storage cells and the plurality of word lines are configured to enable reading of information from the storage cells, wherein the information is configured in a plurality of first type portions which respectively include a plurality of second type portions, and the information is stored by the plurality of storage cells in a distribution that ensures two second type portions from a respective first type portion are not stored adjacent to one another.

2. A storage device of claim 1, wherein the first type portion is a codeword and the second type portion is a data chunk.

3. A storage device of claim 1, wherein logical pages are divided into the second type portions and the second type portions are interleaved in the plurality of storage cells included in a storage block.

4. A storage device of claim 1, wherein the distribution evenly spreads the second type portions across the plurality of storage cells included in a storage block.

5. A storage device of claim 3, wherein the second type portions are evenly spread over the storage block even if error rate noise is not averaged or evenly distributed.

6. A storage device of claim 3 wherein page-to-page variation is mitigated by the distribution of data chunks within a block.

7. A storage device of claim 1, wherein a bit level in one of the plurality of storage cells is programmed in one step without an intermediate transition.

8. A storage device of claim 1, wherein some of the plurality of second storage type portions stored in one physical page configuration are from multiple different logical page configurations.

9. A method comprising:
receiving information for storage;
encoding the information in codewords;
dividing the codewords into portions of codewords; and
distributing the portions so that two portions from a single codeword are not stored in adjacent physical storage cells.

10. The method of claim 9, further comprising associating the codewords with a logical storage page based upon a logical relationship of the codewords.

11. The method of claim 9, wherein the two portions from a single codeword associated with a logical storage page are stored in two different physical storage pages.

12. The method of claim 9, wherein a resulting distribution increases device longevity.

13. The method of claim 9 wherein a resulting distribution facilitates interference mitigation.

14. The method of claim 9, wherein a resulting distribution facilitates error correction and fault tolerance.

15. A storage device comprising:
a plurality of storage cells configured to store information; and
a control component configured to control storage of information in the plurality of storage cells, wherein two portions of information associated with a logical codeword are stored in nonadjacent storage cells included in the plurality of storage cells

16. A storage device of claim 15, wherein reads and writes are applied to a physical page included in a block of physical storage pages and erasures are applied to the block.

17. A storage device of claim 15, wherein a logical page is divided into data chunks of encoded data and the data chunks of encoded data are arranged to ensure logically related data chunks from logical pages are distributed over the block of physical storage pages.

18. A storage device of claim 15, wherein one of the pluralities of storage cells includes a transistor.

19. A storage device of claim 15, wherein one of the pluralities of storage cells is a multiple bit storage cell.
